(19) United States
(12) Patent Application Publication
(10) Pub. No.: US 2007/0284357 A1
(43) Pub. Date: Dec. 13, 2007

(54) INDUCTION-HEATING HEATER DEVICE AND IMAGE FORMING DEVICE

(76) Inventors: Hiroyuki Takahashi, Kanagawa (JP); Tohru Nagatsuma, Kanagawa (JP); Yuji Matsuda, Tokyo (JP); Atsuki Iwata, Tokyo (JP); Eiji Nemoto, Tokyo (JP); Manabu Kodama, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/739,923

(22) Filed: Apr. 25, 2007

(30) Foreign Application Priority Data
May 11, 2006 (JP) 2006-132251

(51) Int. Cl. H05B 1/00

(52) U.S. Cl. 219/216; 219/510

(57) ABSTRACT

A heater device includes a heating unit which includes a heating element that generates heat using an induction-heating method. A power supply part supplies a driving current to the heating unit. A first high-frequency component cutoff unit is connected to the power supply part. A switching unit controls the supply of the driving current from the power supply part to the heating unit. A second high-frequency component cutoff unit is connected to the switching unit. And a connection unit connects the first high-frequency component cutoff unit and the second high-frequency component cutoff unit.

### BACKGROUND OF THE INVENTION

1. Field of the Invention

This invention relates to an induction-heating heater device which causes a heating element to produce heat using an induction-heating method. Moreover, this invention relates to an image forming device, such as a copier, a printer or a facsimile, which includes a heater device with which a toner on a recording sheet is fixed to the recording sheet by heating and pressurization.

2. Description of the Related Art

In copiers or printers, a toner image formed on the photoconductor drum is transferred to a recording sheet, and thereafter the recording sheet is heat treated by the fixing roller which is a fixing unit. Consequently, image formation is performed so that an image is formed on the recording sheet. In the above-mentioned fixing unit, the fixing roller which is heated by a heating member, such as a halogen lamp heater, and the pressurizing roller are arranged opposite to each other. In the most common fixing unit, a mutual pressure applied part (which is called a nip part) is formed between the pressurizing roller and the fixing roller, and a recording sheet is interposed at the nip part under pressure between the fixing roller and the pressurizing roller, and the recording sheet to which the toner image is transferred is subjected at the nip part to heat and pressure.

In recent years, the environmental problem becomes important, and energy saving of image forming devices, such as copiers and printers, is progressing. The demand in considering the energy saving of image forming devices is to reduce the power dissipation of a fixing device which fixes toner to a recording sheet.

On the other hand, there is another demand of a user who uses an image forming device from its standby state, and this demand is to shorten the time needed to start image formation from the standby state of the image forming device. To meet such a demand, the temperature of the fixing roller is maintained at a given temperature which is slightly lower than the fixing temperature. This allows the temperature of the fixing roller to rise to the image-formation permitted temperature immediately at the time of using the image forming device. Thereby, it is possible to keep the user from waiting for rising of the temperature of the fixing roller.

In this case, a certain amount of electric power must be supplied to the fixing roller during the standby state, and excessive electric power is consumed due to this power supply. In order to realize further reduction of the power dissipation, it is desirable to make the power dissipation of the fixing roller at the time of the standby state into zero.

However, if the electric power supplied to the fixing roller at the time of the standby state is made into zero, the temperature of the fixing roller falls with time. The fixing roller is mainly made of a thick rubber layer and has a large heat capacity. Once the temperature of the fixing roller falls, it takes a long heating time in a range from several minutes to more than ten minutes, in order to raise the temperature up to the image-formation permitted temperature (which is about 180 degrees C.). Namely, when the user uses the image forming device in the standby state immediately, the demand for shortening the time needed to start image formation from the standby state of the image forming device cannot be satisfied.

For this reason, the mechanism for raising the fixing roller temperature promptly is needed for realizing the energy saving of image forming devices.

Generally, a halogen lamp heater has been used for heating the fixing roller. Since the heating efficiency of the heating method using a halogen lamp heater is poor and the power dissipation thereof is large, development of a heating unit having a short rising time with sufficient heating efficiency which would be an alternative of a halogen lamp heater is demanded in order to realize energy saving of the image forming device.

In the circumferences, a fixing unit which is comprised of an excitation coil, a heating roller, a fixing belt, a fixing roller and a pressurizing roller is being increasingly adopted in recent years. In the fixing unit of this composition, according to the eddy current generated in the excitation coil, the heating roller is caused to generate heat, the heat of the heating roller is transferred to the fixing roller by the fixing belt molded with a material having a small heat capacity, such as polyimide, and a recording sheet is subjected to heat at the nip part between the fixing roller and the pressurizing roller so that a toner image is fixed to the recording sheet.

In the fixing unit of this composition, it is unnecessary for the heating roller to apply pressure to toner, and the heating roller can be constructed in a small size and thickness. And the heat capacity of the entire fixing unit can be made small by using the fixing belt made of a material with a small heat capacity, and it is possible to shorten the rising time to the image-formation permitted temperature.

The fixing unit of the above-mentioned composition will be called an induction-heating fixing unit. And this induction-heating fixing unit is considered as the most attractive one having the following features: the heating efficiency is good; the rising time to the image-formation-permitted temperature can be shortened remarkably; and some contribution can be made to the environmental problem.

However, the induction-heating heater device mentioned above has the following problems. The induction-heating fixing unit includes the heating unit in which the excitation coil which generates an alternating-current magnetic field for causing the heating element to generate heat is provided, and the power supply part which supplies a high-frequency current to the excitation coil. The heating unit and the power supply part are connected by the connection unit. Since a large amount of high-frequency current flows into the connection unit, the problem that meeting the EMI (electromagnetic interference) related standard requirement is difficult due to occurrence of radiation noises, the problem that a malfunction of the control circuit is caused by the noises, and the problem that the cost of noise prevention parts for prevention of the noises is increased will arise.

In addition, it is necessary that the electric wires used in the connection unit 211, is high voltage resistant and capable of conducting a large amount of current, and the cost of the electric wires will be increased. Moreover, if the electric wires in the connection unit 211 are too long, the current waveform varies and radiation noises increase. In such a case, it is impossible to arrange the power supply part 210 and the heating part 209 at locations which are separate from each other beyond a certain fixed distance, and such distance-related restrictions arise. Thus, the restrictions related to the location where the power supply part 210 is arranged will arise.

Japanese Laid-Open Patent Application No. 2004-200005 discloses an induction-heating roller device, a heating unit and an image forming device using the same. In this roller device, the leakage current is reduced to fall within the standard requirement and the occurrence of a malfunction due to common-mode noises is suppressed. The roller device of Japanese Laid-Open Patent Application No. 2004-200005 is provided with a power-factor compensation capacitor arranged near the induction coil and grounded at its middle point, and a high-frequency power supply, a high-frequency transmission path, and a matching circuit. According to this induction-heating roller device, cost reduction can be allowed by using small-diameter electric wires, and the radiation noise which is radiated from the high frequency transmission path can be reduced.

However, a large amount of high-frequency current flows even if the above-mentioned power-factor compensation capacitor and matching circuit are provided. The diameter of the electric wires used must be larger than a given minimum diameter and using high-voltage-resistant electric wires is unavoidable, and the effect of cost reduction is not sufficient. Similarly, a large amount of electric current must be flowed in the device, and the reduction of radiation noises is not adequate.

### SUMMARY OF THE INVENTION

According to one aspect of the invention, there is provided an improved heater device in which the above-described problems are eliminated.

According to one aspect of the invention there is provided a heater device which prevents occurrence of radiation noises due to the flow of a large amount of high-frequency current, reduces the cost of noise prevention parts, reduces the cost of electric wires used in the connection unit, and eliminates the restriction related to the location where the power supply part is arranged.

In an embodiment of the invention which solves or reduces one or more of the above-mentioned problems, there is provided a heater device comprising: a heating unit including a heating element that generates heat using an induction-heating method; a power supply part supplying a driving current to the heating unit; a first high-frequency component cutoff unit connected to the power supply part; a switching unit controlling the supply of the driving current from the power supply part to the heating unit; a second high-frequency component cutoff unit connected to the switching unit; and a connection unit connecting the first high-frequency component cutoff unit and the second high-frequency component cutoff unit.

In an embodiment of the invention which solves or reduces one or more of the above-mentioned problems, there is provided a heater device comprising: a heating unit including a heating element that generates heat using an induction-heating method; a power supply part supplying a driving current to the heating unit; a first high-frequency component cutoff unit connected between the power supply part and a commercial power supply; a switching unit controlling the supply of the driving current from the power supply part to the heating unit; a second high-frequency component cutoff unit connected to the switching unit; and a connection unit connecting the second high-frequency component cutoff unit and the power supply part.

In an embodiment of the invention which solves or reduces one or more of the above-mentioned problems, there is provided a heater device comprising: a heating unit including a heating element that generates heat using an induction-heating method; an LC resonant circuit including an excitation coil and a resonance capacitor; a power supply part supplying a driving current to the LC resonant circuit; a high-frequency component cutoff unit connected between the power supply part and a commercial power supply; and a switching unit controlling the supply of the driving current from the power supply part to the LC resonant circuit, wherein the switching unit, the resonance capacitor, the power supply part, and the high-frequency component cutoff unit are implemented on a same substrate.

The above-mentioned heater device may be configured so that the switching unit is a single voltage resonance type switching unit.

The above-mentioned heater device may be configured so that the switching unit is a half bridge type switching unit.

According to embodiments of the heater device and the image forming device of the invention, a large amount of high-frequency current does not flow in the connection unit, and occurrence of radiation noises is eliminated. The EMI related standard requirement can be easily met and the cost of noise prevention parts can be reduced. The problem of a malfunction of the control circuit due to the noises does not arise. Since no high voltage is supplied to the connection unit, it is not necessary to use the electric wires which are high voltage resistant and conduct a large amount of current. The cost of wiring material can be made low. Moreover, the problem that if the electric wires in the connection unit are too long, the current waveform varies and occurrence of radiation noises is increased may not occur, distance restrictions will not arise. Therefore, the restrictions related to the location where the power supply part is arranged will not arise.

### BRIEF DESCRIPTION OF THE DRAWINGS

Other objects, features and advantages of the present invention will be apparent from the following detailed description when reading in conjunction with the accompanying drawings.

FIG. 1 is a diagram showing the composition of a fixing driver device in an embodiment of the invention.

FIG. 2 is a diagram showing the composition of an induction-heating fixing unit in the related art.

FIG. 3 is a diagram showing the composition of an image forming device in an embodiment of the invention.

FIG. 4 is a diagram showing the composition of a fixing unit and a fixing driver device.

FIG. 5A, FIG. 5B, FIG. 5C, FIG. 5D, FIG. 5E and FIG. 5F are diagrams showing waveforms of current which flows into the respective parts of a fixing driver device in an embodiment of the invention.

FIG. 6 is a diagram showing the composition of a fixing driver device in an embodiment of the invention.

FIG. 7 is a diagram showing the composition of a fixing driver device in an embodiment of the invention.

FIG. 8 is a diagram showing the composition of a fixing driver device in an embodiment of the invention.

FIG. 9 is a diagram showing the composition of a fixing driver device in an embodiment of the invention.

FIG. 10 is a diagram showing the composition of a fixing driver device in an embodiment of the invention.

### DETAILED DESCRIPTION OF PREFERRED EMBODIMENTS

Before describing embodiments of the invention, a fixing driver device in the related art will be explained in order to provide better understanding of the invention.

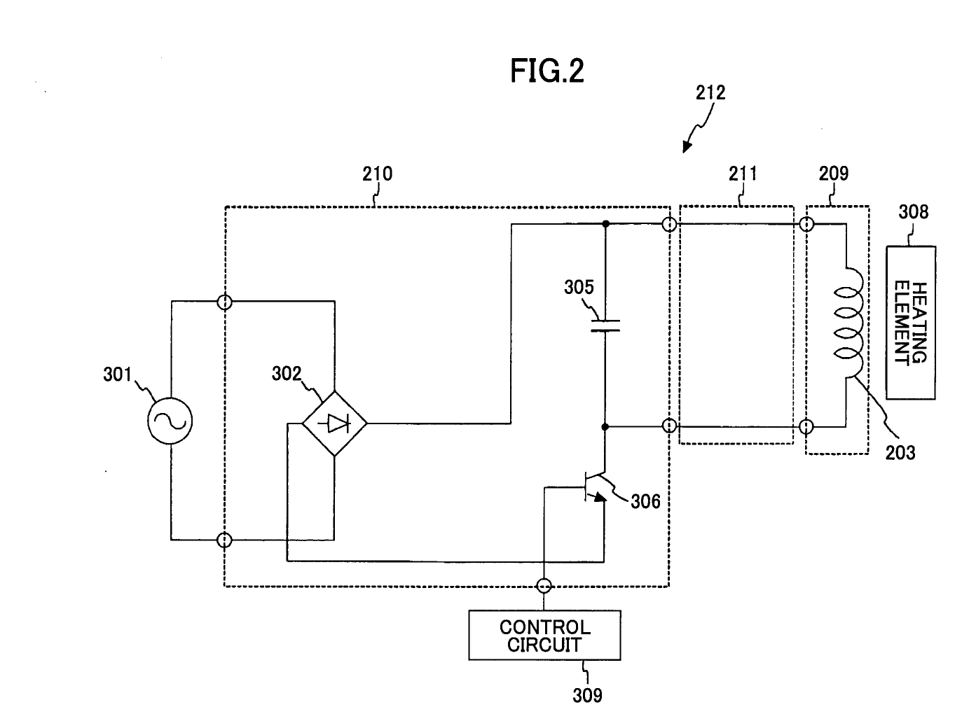

FIG. 2 shows the composition of an induction-heating fixing unit in the related art.

As shown in FIG. 2, the induction-heating fixing unit includes a power supply part 210, a heating part 209, and a connection unit 211 which connects the power supply part 210 and the heating part 209. A commercial power supply 301 is connected to a rectifier circuit 302, and this rectifier circuit 302 performs full-wave rectification of the commercial alternating current voltage. The full-wave rectification voltage output of the rectifier circuit 302 is connected to one end of a resonance capacitor 305.

The other end of the capacitor 305 is connected to the collector of a switching unit 306, and the emitter of the switching unit 306 is connected to the low-voltage side output of the rectifier circuit 302. The ends of the resonance capacitor 305 are connected to the ends of an excitation coil 203 by two electric wires in the connection unit 211. The excitation coil 203 and the resonance capacitor 305 constitute an LC parallel resonant circuit.

When a driving signal outputted from a control circuit 309 is sent to the base of the switching unit 306, and the driving signal from the control circuit 309 causes the switching unit 306 to be turned on and off, so that a high-frequency current flows into the excitation coil 203. And when an alternating-current magnetic field irradiates a heating element 308, an eddy current occurs on the surface of the heating element 308 and heat is generated.

However, the induction-heating heater device of FIG. 2 has the following problems. The induction-heating fixing unit includes the heating part 209 in which the excitation coil 203 which generates an alternating-current magnetic field for causing the heating element 308 to generate heat is provided, and the power supply part 210 which supplies a high-frequency current to the excitation coil 203. The heating part 209 and the power supply part 210 are connected by the connection unit 211. Since a large amount of high-frequency current flows into the connection unit 211, the problem that meeting the EMI (electromagnetic interference) related standard requirement is difficult due to occurrence of radiation noises, the problem that a malfunction of the control circuit is caused by the noises, and the problem that the cost of noise prevention parts for prevention of the noises is increased will arise.

In addition, it is necessary that the electric wires used in the connection unit 211, is high voltage resistant and capable of conducting a large amount of current, and the cost of the electric wires will be increased. Moreover, if the electric wires in the connection unit 211 are too long, the current waveform varies and radiation noises increase. In such a case, it is impossible to arrange the power supply part 210 and the heating part 209 at locations which are separate from each other beyond a certain fixed distance, and such distance-related restrictions arise. Thus, the restrictions related to the location where the power supply part 210 is arranged will arise.

A description will be given of embodiments of the invention with reference to the accompanying drawings.

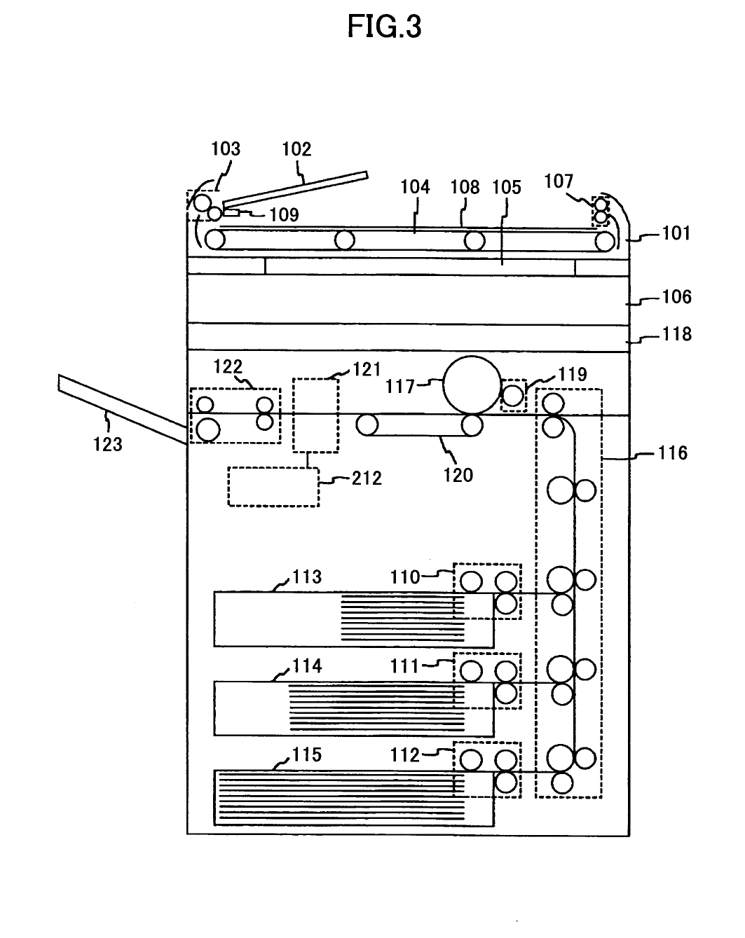

FIG. 3 shows the composition of an image forming device in an embodiment of the invention.

The image forming device in this embodiment has multiple image forming functions including a copier function and functions other than the copier function, for example, a printer function and a facsimile function. One of the multiple functions: the copier function, the printer function and the facsimile function can be selected by using the application change key of the operation panel, and the selected function can be activated.

When the copier function is selected, the image forming device is set to the copy mode. When the printer function is selected, the image forming device is set to the print mode. When the function mile function is selected, the image forming device is set to the facsimile mode.

In the copy mode, the image forming device operates as follows. In an automatic document feeder (ADF) 101, a set of document sheets are placed on a document base 102 with their image surfaces turned upside, and, when the start key on the operation panel (which is not illustrated) is pressed, feeding of a document sheet at the bottom of the document sheets is performed to the predetermined position on the contact glass of a document base 105 through a feeding roller 103 and a feeding belt 104.

The ADF 101 has a document counting function which counts up the number of document sheets each time the feeding of one document sheet is completed.

Image information of a document on the contact glass 105 is read by an image reader 106 which is an image input unit, and then the document is transported by means of a feeding belt 104 and an ejection roller 107, and ejected to an ejection stand 108.

The feeding roller 103, the feeding belt 104, and the ejection roller 107 are driven by the conveyance motor which is not illustrated. When presence of a following document on the document base 102 is detected by a document sensor 109, the feeding of the document, the reading of image information and the ejection of the document are performed similarly.

A first feeder 110, a second feeder 111, and a third feeder 112, each of which constitutes a feeding unit, are provided to transport, when one feeding unit is chosen, a recording sheet contained in one of a first tray 113, a second tray 114 and a third tray 115, and this recording sheet is transported to the position where it contacts a photoconductor 117 which is an image support object, by a vertical conveyance unit 116. For example, a photoconductor drum is used as the photoconductor 117, and the photoconductor drum is rotated at a constant speed by a main motor.

The image data read from the document by the image reader 106 is processed through the image processing unit (which is not illustrated) and it is converted into optical information by the optical writing unit 118 which is a writing unit. After the surface of the photoconductor drum 117 is uniformly charged by the charging unit (which is not illustrated), the surface is exposed to light according to the optical information from the writing unit 118, so that an electrostatic latent image is formed on the photoconductor drum 117.

The electrostatic latent image on the photoconductor drum 117 is developed by a developing unit 119, so that the latent image is turned into a toner image.

A transport belt 120 serves as each of a sheet conveying unit and a transfer unit. A transfer bias voltage is supplied from the high voltage power supply (which is not illustrated) to the transport belt 120. The transport belt 120 transfers the toner image on the photoconductor drum 117 to the recording sheet, while the recording sheet from the vertical conveyance unit 116 is transported at a uniform speed which is equal to the rotating speed of the photoconductor drum 117. The toner image is fixed to the recording sheet by a fixing unit 121, and this recording sheet is ejected to a sheet output tray 123 by a sheet ejection unit 122.

The surface of the photoconductor drum 117 is cleaned by the cleaning device which is not illustrated after the toner image is transferred. In this embodiment, the photoconductor drum 117, the charging unit, the optical writing unit 118, the developing unit 119, and the transfer unit constitute an image formation unit which forms an image on a recording sheet in accordance with image data. A fixing driver device 212 is provided to supply a driving current (electric power) to the fixing unit 121.

In the print mode, the image forming device operates as follows. Image data from an external device is inputted to the optical writing unit 118 (instead of the image data supplied from the image processing unit), and an image is formed on a recording sheet by the above-mentioned image forming unit.

In the facsimile mode, the image forming device operates as follows. The image data from the above-mentioned image reading unit is transmitted to a receiving facsimile device by the facsimile transmission/reception unit which is not illustrated. Or, image data from a transmitting facsimile device is received by the facsimile transmission/reception unit and inputted to the optical writing unit 118 (instead of the image data supplied from the image processing unit), and an image is formed on a recording sheet by the above-mentioned image forming unit.

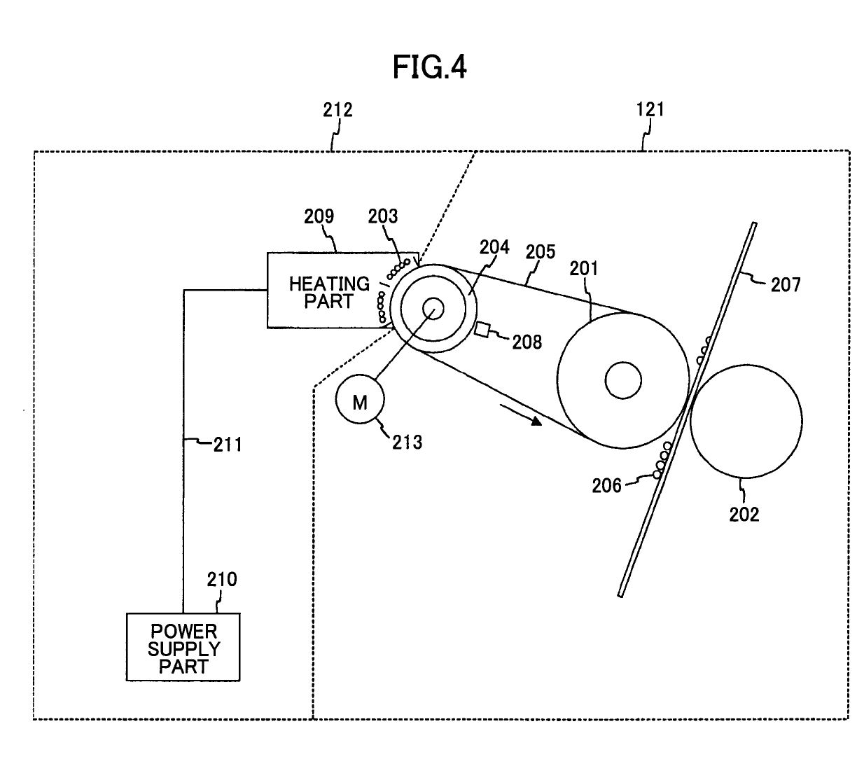

FIG. 4 shows the composition of the fixing unit 121 and the fixing driver device 212.

As shown in FIG. 4, in the fixing unit 121, a fixing roller 201 which is a fixing member made of an elastic material, such as silicone rubber, and a pressurizing roller 202 which is a pressurizing member are pressed onto each other under a fixed pressure exerted by a force applying unit which is not illustrated.

The fixing roller 201 and the pressurizing roller 202 are made of a comparatively thick elastic member, in order to secure an adequately large width of the nip part at the time of fixing.

Near the fixing roller 201, a heating roller 204 which is made of a material with a good thermal conductivity, such as metal, is arranged. The fixing roller 201 and the heating roller 204 are arranged so that they are rotated by an endless fixing belt 205 which is molded with a resin material having a small heat capacity, such as polyimide, etc.

A fixed tension is applied to the fixing belt 205 by the tension roller which is not illustrated, and the fixing belt 205 is provided so that any sliding action of the fixing belt 205 to each roller may not occur as much as possible. The heating roller 204 is rotated by a motor 213 through the gear engagement which is not illustrated.

Near the heating roller 204, a heating part 209 in which an excitation coil 203 is provided as its component part is arranged. An alternating-current magnetic field is induced to the excitation coil 203 when a high frequency current is supplied from a power supply part 210 to the excitation coil 203. This magnetic field is irradiated to the heating roller 204, and an eddy current occurs on the surface of the heating roller 204 so that heat is generated.

This heat is transmitted to the fixing belt 205, and the heating roller 204 is rotated and the fixing belt 205 is moved to the nip part of the fixing roller 201, so that toner 206, which is transferred to the transported recording sheet 207, is fused by the heat. In this embodiment, the heating roller 204 made of a metallic material and the fixing belt 205 having a small heat capacity are used in fusing the toner 206. It is possible for this embodiment to raise the heating temperature rapidly, and the heating time or the rising time can be shortened remarkably. It is unnecessary to maintain the fixing roller 201 at the image-formation permitted temperature beforehand, and some contribute can be made to the environmental problem.

A contact type temperature sensor 208 is arranged on the side of the heating roller 204, opposite to the side where the magnetic field from the excitation coil 203 is irradiated, so that the sensor 208 contacts the roller 204. A surface temperature of the heating roller 204 is measured using this temperature sensor 208, and the magnetic field generated in the excitation coil 203 is controlled so as to keep the surface temperature at a fixed temperature, thereby preventing the fixing performance from becoming poor due to temperature unevenness.

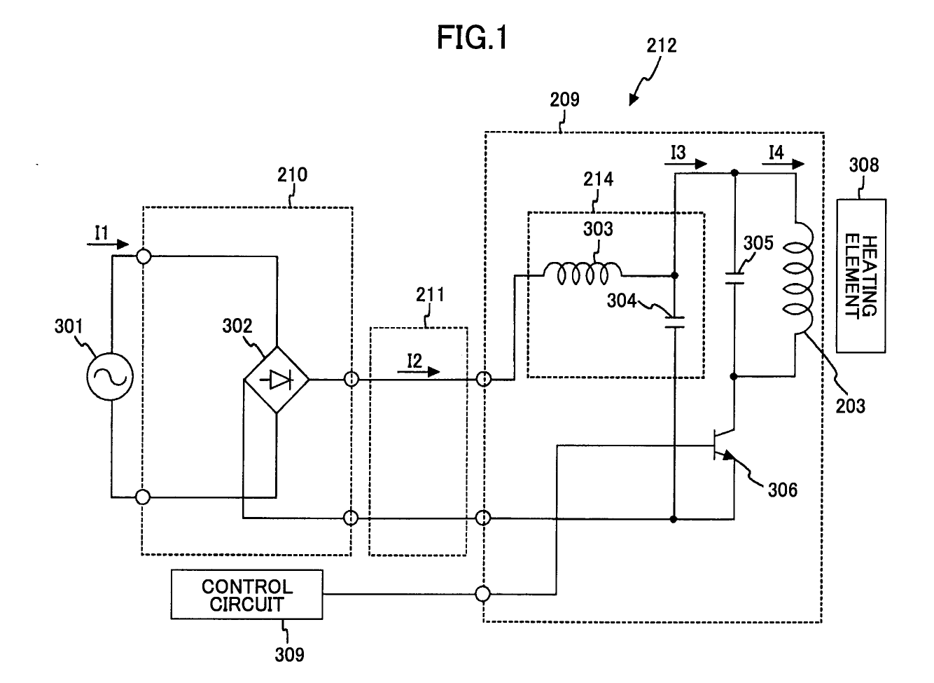

Operation of the temperature control will be explained with reference to FIG. 1 and FIG. 4.

The temperature sensor 208 of FIG. 4 measures the surface temperature of the heating roller 204, and outputs the measured temperature information to a control circuit 309 of FIG. 1. The control circuit 309 controls the timing of switching ON and OFF of the switching unit 306, so that the surface temperature of the heating roller 204 is maintained at a fixed temperature.

Namely, when the surface temperature of the heating roller 306 is lower than a target temperature, the control circuit 309 controls the timing so that the ON time of the switching unit 306 is made longer, and, when the surface temperature of heating roller 306 is higher than the target temperature, the control circuit 309 controls the timing so that the ON time of the switching unit 306 is made shorter. The switching unit 306 is driven by the driving signal outputted from the control circuit 309.

FIG. 1 shows the composition of a fixing driver device 212 in an embodiment of the invention.

As shown in FIG. 1, a commercial power supply 301 is connected to a rectifier circuit 302, and this rectifier circuit 302 performs full-wave rectification of the commercial alternating current voltage.

The full-wave rectification voltage output of the rectifier circuit 302 is connected to one of two electric wires of a connection unit 211, and this electric wire is connected to one end of a choke coil 303. The other end of the choke coil 303 is connected to one end of a capacitor 304. Suppose that this end is a high-voltage side of the capacitor 304.

The other end of the capacitor 304 is connected to the other of the two electric wires of the connection unit 211. Suppose that the other end is a low-voltage side of the capacitor 304. The other electric wire of the connection unit 211 is connected to the low-voltage side output of the rectifier circuit 302. The choke coil 303 and the capacitor 304 constitute a high-frequency component cutoff unit 214.

The high-voltage side of the capacitor 304 is connected to one end of an LC parallel resonant circuit which includes an excitation coil 203 and a resonance capacitor 305. The other end of the LC parallel resonant circuit is connected to the collector of a switching unit 306, and the emitter of the switching unit 306 is connected to the low-voltage side of the capacitor 304.

A driving signal outputted from the control circuit 309 is connected to the base of the switching unit 306. When this driving signal from the control circuit 309 causes switching ON and OFF of the switching unit 306, a high frequency current flows into the excitation coil 203 and an alternating-current magnetic field is irradiated to a heating element 308, so that an eddy current occurs on the surface of the heating element 308 and heat is generated.

The heating element 308 is equivalent to the heating roller 204 in FIG. 4. The circuit including the switching unit 306, the excitation coil 203, and the resonance capacitor 305 in FIG. 1 is called a single voltage resonance type switching unit. In this embodiment, a transistor is used as the switching unit 306. Alternatively, FET or IGBT may be used instead.

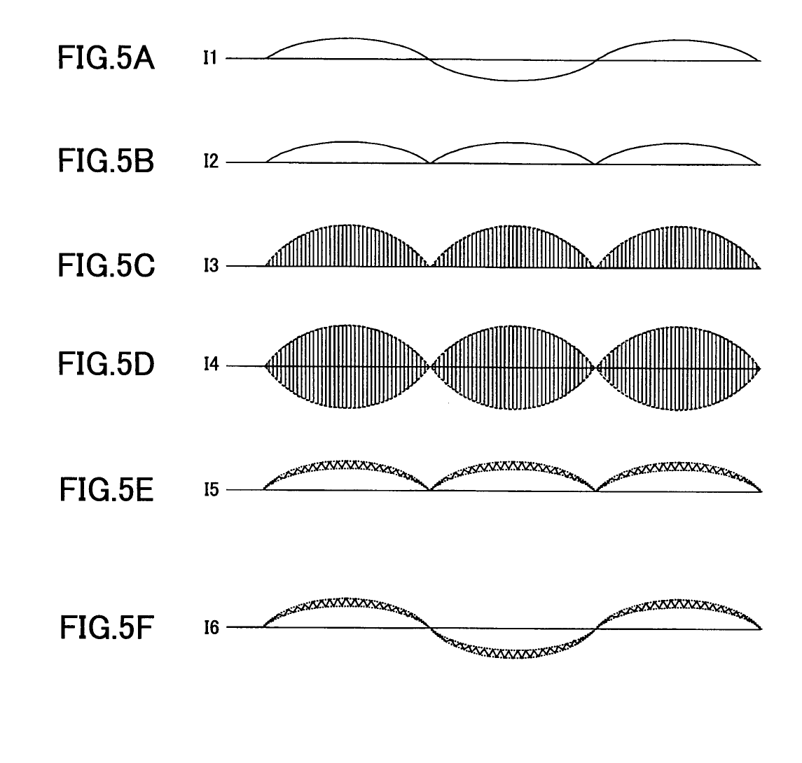

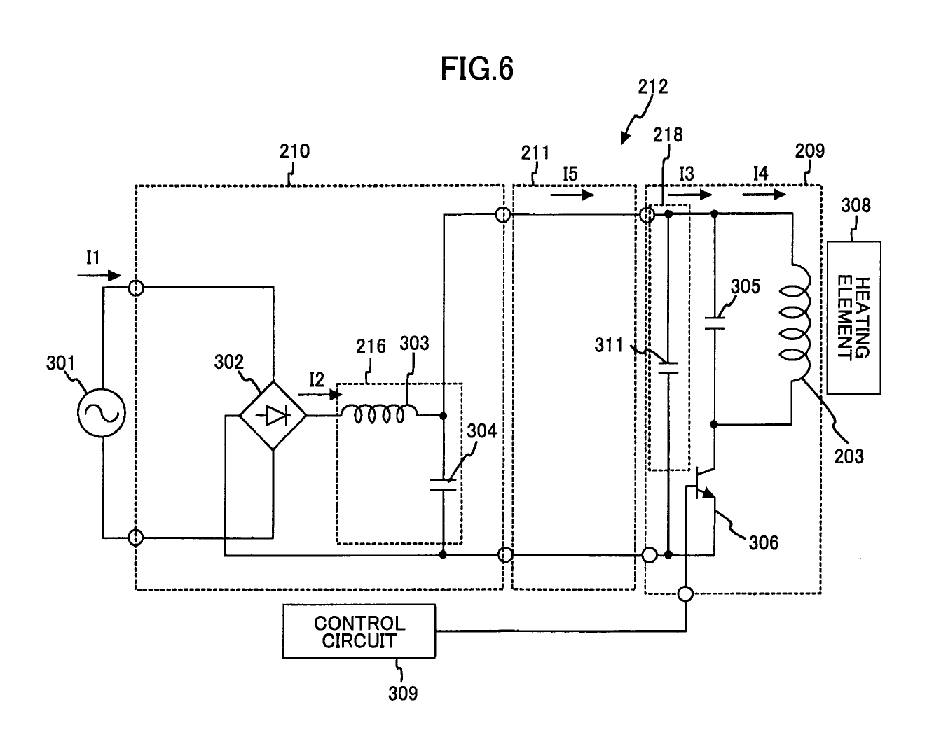

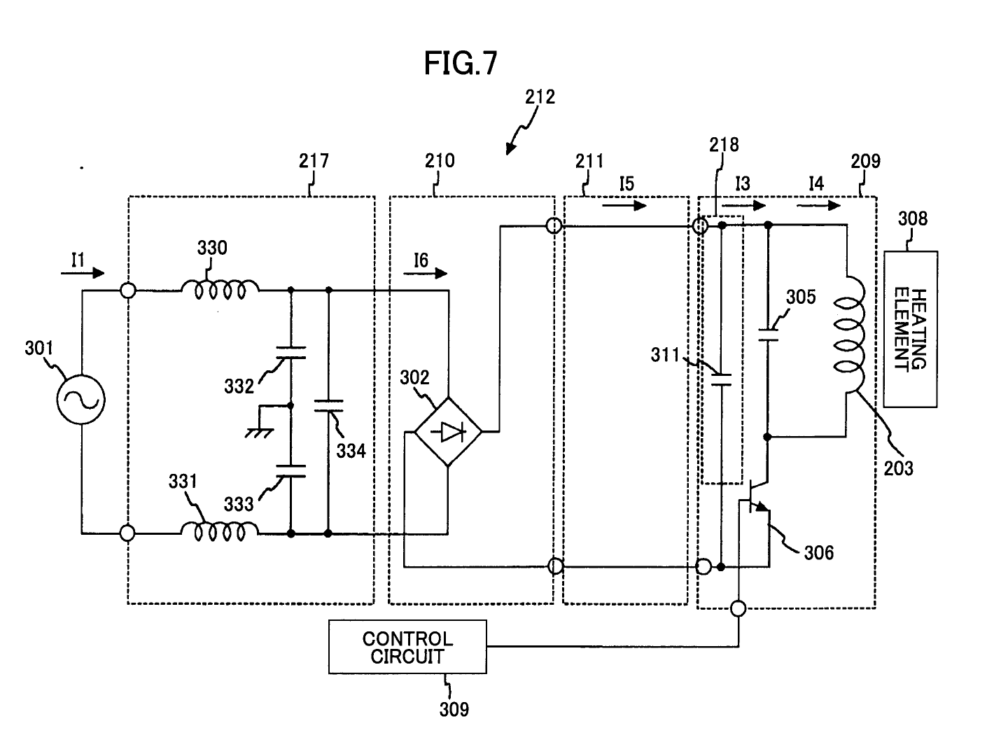

FIG. 5A, FIG. 5B, FIG. 5C, and FIG. 5D show the waveforms of currents I1, I2, I3, and I4 in the embodiment of FIG. 1, respectively. FIG. 5E and FIG. 5F show the waveforms of currents I5 and I6 in the embodiments of FIG. 6 and FIG. 7, respectively, which will be explained later.

In FIG. 1, I1 denotes a current which is supplied to the power supply part 210 from the commercial power supply 301, and this current has the waveform of FIG. 5A. I2 denotes a current which is supplied to the heating part 209 from the power supply part 210 and which flows through the connection unit 211, and this current has the waveform of FIG. 5B.

In FIG. 1, I3 denotes a current which is supplied from the high-frequency component cutoff unit 214, including the choke coil 303 and the capacitor 304, to the LC parallel resonant circuit, including the excitation coil 203 and the resonance capacitor 305, and this current has the waveform of FIG. 5C. I4 denotes a current which flows into the excitation coil 203, and this current has the waveform of FIG. 5D.

As shown in FIG. 5A, the current I1 is in the shape of a sinusoidal wave according to the power supply frequency, and it does not contain a high-frequency component.

As shown in FIG. 5B and FIG. 5C, a high-frequency component is cut off by the high-frequency component cutoff unit 214 including the choke coil 303 and the capacitor 304, and the current I2 is changed into a full-wave rectification wave containing no high-frequency component as in the current I3 shown in FIG. 5C (which will be mentioned later).

As shown in FIG. 5C, the current I3 is supplied to the LC parallel resonant circuit which includes the excitation coil 203 and the resonance capacitor 305. When the switching unit 306 is in ON state, the charging current flows into the resonance capacitor 305. When the charging of the resonance capacitor 305 is completed, the amplitude of the current I3 becomes zero.

Subsequently, when the switching unit 306 is in OFF state, the resonance capacitor 305 supplies current to the excitation coil 203. When the discharging of the resonance capacitor is completed, the voltage becomes zero. The charging and discharging of the resonance capacitor 305 will be repeated by the repetition of the switching ON and OFF of the switching unit 306, and the current I3 is in a single-polarity, high-frequency oscillatory waveform having the envelope of the full-wave rectification voltage waveform of the commercial power supply 301.

As shown in FIG. 5E, the current I4 flows into the excitation coil 203 when the LC parallel resonant circuit is a resonant condition. When the switching unit 306 is in ON state, the charging current flows into the resonance capacitor 305, and it flows also into the excitation coil 203. In this case, the current does not easily flows through the excitation coil 203 because of its inductance characteristics, unlike the resonance capacitor 305. When the switching unit 306 is set in OFF state at the end of the period of a fixed time after it is set in ON state, the potential of the excitation coil 203 is lower than the potential of the resonance capacitor 305. Therefore, the charging current from the resonance capacitor 305 flows into the excitation coil 203.

Subsequently, when the discharging of the resonance capacitor 305 is started, the charging current from the excitation coil 203 flows into the resonance capacitor 305. When the switching ON and OFF of the switching unit 306 is repeated, the LC resonant condition is obtained. The resonance frequency f0 and the resonance cycle T0 in this condition are represented by the following formulas: f0=1/(2π√LC), T0=2π√LC.

The resonant condition can be maintained by adjusting the timing of switching ON and OFF of the switching unit 306.

As mentioned above, the current I4 is in a both-polarity, high-frequency oscillatory waveform having the envelope of the full-wave rectification voltage waveform of the commercial power supply 301. Since the LC resonant condition is obtained, the voltage between the ends of the excitation coil 203 is on the order of several hundred volts.

As explained above, when the switching unit 306 turns on and off the supply of the current to the LC parallel resonant circuit which includes the excitation coil 203 and the resonance capacitor 305, the current I3 containing the high-frequency component flows into the LC parallel resonant circuit. However, since the current I3 which flows into the LC parallel resonant circuit is supplied through the high-frequency component cutoff unit 214 which includes the choke coil 303 and the capacitor 304, a high-frequency component does not exist in the current I2 which flows into the connection unit 211. Therefore, the problem that meeting the EMI related standard requirement is difficult due to radiation noises generated in the connection unit 211, or the problem of a malfunction of the control circuit function caused by the noises does not arise.

Since a high voltage is not applied to the connection unit 211, it is not necessary to use the electric wires which are high voltage resistant and capable of conducting a large amount of current, and the cost of wiring material can be made low. Moreover, the problem that if the electric wires in the connection unit 211 are too long, the current waveform varies and occurrence of radiation noises is increased does not arise, and the distance restrictions will not arise. Therefore, the restrictions related to the location where the power supply part 210 is arranged will not arise.

In the embodiment of FIG. 1, the component parts of the heating part 209 are implemented on the same substrate (or a printed circuit board (PCB)), and pattern wiring of the respective component parts is carried out so that the length of the wiring may be the shortest distance on the PCB. Especially, it is desirable that each of the excitation coil 203, the resonance capacitor 305 and the switching unit 306 is connected to the high-frequency component cutoff unit 214 which includes the choke coil 303 and the capacitor 304 by the shortest distance. Since some high frequency current flows into the respective parts mentioned above, radiation noises from the wiring can be reduced by shortening the length of the wiring which connects the respective parts.

However, the arrangement position of the excitation coil 203 is affected according to a relative position to the heating element 308, and the arrangement position of the choke coil 303 is affected according to the outside size of the choke coil 303. It is desirable that at least the resonance capacitor 305, the switching unit 306, and the capacitor 304 of the high-frequency component cutoff unit 214 are connected together by the shortest possible distance.

It is not necessarily required that the component parts of the heating part 209 are implemented on the same PCB. The respective component parts of the heating part 209 may be implemented on separate substrates such that they are connected together by the shortest distance.

Next, FIG. 6 shows the composition of a fixing driver device 212 in an embodiment of the invention.

As shown in FIG. 6, the commercial power supply 301 is connected to the rectifier circuit 302, and this rectifier circuit 302 performs full-wave rectification of the commercial alternating current voltage. The full-wave rectification voltage output of the rectifier circuit 302 is connected to one end of the choke coil 303. The other end of the choke coil 303 is connected to one end of the capacitor 304. Suppose that this end is a high-voltage side of the capacitor 304.

The other end of the capacitor 304 is connected to the low-voltage side output of the rectifier circuit 302. Suppose that the other end is a low-voltage side of the capacitor 304. The choke coil 303 and the capacitor 304 constitute a first high-frequency component cutoff unit 216.

The high-voltage side of the capacitor 304 is connected to one of the two electric wires of the connection unit 211, and this electric wire is connected to one end of a capacitor 311. Suppose that the end is a high-voltage side of the capacitor 311.

The other end of the capacitor 311 is connected to the other of the two electric wires of the connection unit 211. Suppose that the other end is a low-voltage side of the capacitor 311. The other electric wire of the connection unit 211 is connected to the low-voltage side of the capacitor 304. The capacitor 311 constitutes a second high-frequency component cutoff unit 218.

The high-voltage side of the capacitor 311 is connected to one end of the LC parallel resonant circuit which includes the excitation coil 203 and the resonance capacitor 305. The other end of the LC parallel resonant circuit is connected to the collector of the switching unit 306, and the emitter of the switching unit 306 is connected to the low-voltage side of the capacitor 311.

A driving signal outputted from the control circuit 309 is connected to the base of the switching unit 306. When this driving signal from the control circuit 309 causes switching ON and OFF of the switching unit 306, a high frequency current flows into the excitation coil 203, and an alternating-current magnetic field is irradiated to the heating element 308, so that an eddy current occurs on the surface of the heating element 308 and heat is generated.

In FIG. 6, I1 denotes a current supplied to the power supply part 210 from the commercial power supply 301, and this current has the waveform of FIG. 5A. I2 denotes a current which flows into the choke coil 303 from the rectifier circuit 302, and this current has the waveform of FIG. 5B.

In FIG. 6, I3 denotes a current which is supplied from the second high-frequency component cutoff unit 218, including the capacitor 311, to the LC parallel resonant circuit, including the excitation coil 203 and the resonance capacitor 305, and this current has the waveform of FIG. 5C. I4 denotes a current which flows into the excitation coil 203, and this current has the waveform of FIG. 5D. I5 denotes a current which flows into the connection unit 211, and this current has the waveform of FIG. 5E.

When the switching unit 306 turns on and turns off the supply of the current to the LC parallel resonant circuit including the excitation coil 203 and the resonance capacitor 305, the current I3 containing the high-frequency component flows into the LC parallel resonant circuit. However, the current I3 which flows into the LC parallel resonant circuit is supplied through the second high-frequency component cutoff unit 218 including the capacitor 311, so that the high-frequency component is cut off from the current I5 which flows into the connection unit 211, although the effect is not enough.

Subsequently, the current I5 which flows into the connection unit 211 is supplied through the first high-frequency component cutoff unit 216 including the choke coil 303 and the capacitor 304, and the high-frequency component is completely cut off from the current I2 which is supplied from the rectifier circuit 302 to the choke coil 303. A high-frequency component does not exist in the current I1 which is supplied from the commercial power supply 301 to the power supply part 210.

In the embodiment of FIG. 1, the filter circuit including the choke coil 303 and the capacitor 304 is used as the high-frequency component cutoff unit. In the embodiment of FIG. 6, only the capacitor 311 is used for this purpose. The effect of the capacitor 311 to cut off the high frequency component is not enough.

However, the capacitor 311 in the embodiment of FIG. 6 is effective as a high-frequency component cutoff unit for reducing radiation noises from the connection unit 211 as much as possible, in a case where a large choke coil 303 or a large capacitor 304 cannot be arranged in the heating part 209 because of the problem of a limited space in an image forming device. Namely, restrictions related to the space of the heating part 209 can be eliminated.

Next, FIG. 7 shows the composition of a fixing driver device 212 in an embodiment of the invention.

As shown in FIG. 7, one end of the commercial power supply 301 is connected to one end of a coil 330, and the other end of the coil 330 is connected to one end of a capacitor 332. This end is called line side 1 of the capacitor 332.

The other end of the commercial power supply 301 is connected to one end of a coil 331, and the other end of the coil 331 is connected to one end of a capacitor 333. This end is called line side 2 of the capacitor 333.

The other end of the capacitor 332 and the other end of the capacitor 333 are connected to the housing of the heater device in the embodiment of FIG. 7.

The line side 1 of the capacitor 332 is connected to one end of a capacitor 334, and the line side 2 of the capacitor 333 is connected to the other end of the capacitor 334. The coil 330, the coil 331, the capacitor 332, the capacitor 333, and the capacitor 334 constitute a first high-frequency component cutoff unit 217.

In the first high-frequency component cutoff unit 217, the capacitor 334 cuts off the noises between the line side 1 and the line side 2, the capacitor 332 cuts off the noises between the line side 1 and the housing, and the capacitor 333 cuts off the noises between the line side 2 and the housing.

The line side 1 of the capacitor 332 and the line side 2 of the capacitor 333 are connected to the two alternating current inputs of the rectifier circuit 302, and the rectifier circuit 302 performs full-wave rectification of the commercial alternating current voltage.

The full-wave rectification voltage output of the rectifier circuit 302 is connected to one of the two electric wires of the connection unit 211, and this electric wire is connected to one end of the capacitor 311. Suppose that this end is a high-voltage side of the capacitor 311.

The other end of the capacitor 311 is connected to the other of the two electric wires of the connection unit 211. Suppose that the other end is a low-voltage side of the capacitor 311. The other electric wire of the connection unit 211 is connected to the low-voltage side output of the rectifier circuit 302. The capacitor 311 constitutes a second high-frequency component cutoff unit 218.

In the embodiment of FIG. 7, with operation of the LC parallel resonant circuit, including the excitation coil 203 and the resonance capacitor 305, the switching unit 306, and the control circuit 309, a high frequency current flows into the excitation coil 203 and an alternating-current magnetic field is irradiated to the heating element 308, so that an eddy current occurs on the surface of the heating element 308 and heat is generated. This is the same as that of the embodiment of FIG. 6.

In FIG. 7, I1 denotes a current which is supplied from the commercial power supply 301 to the first high-frequency component cutoff unit 217 including the coil 330, the coil 331, the capacitor 332, the capacitor 333 and the capacitor 334, and this current has the waveform of FIG. 5A. I6 denotes a current which is supplied from the first high-frequency component cutoff unit 217 to the rectifier circuit 302, and this current has the waveform of FIG. 5F.

In FIG. 7, I3 denotes a current which is supplied from the second high-frequency component cutoff unit 218, including the capacitor 311, to the LC parallel resonant circuit, including the excitation coil 203 and the resonance capacitor 305, and this current has the waveform of FIG. 5C. I4 denotes a current which flows into the excitation coil 203, and this current has the waveform of FIG. 5D. I5 denotes a current which flows into the connection unit 211, and this current has the waveform of FIG. 5E.

When the switching unit 306 turns on and off the supply of the current to the LC parallel resonant circuit including the excitation coil 203 and the resonance capacitor 305, the current I3, containing the high-frequency component, flows into the LC parallel resonant circuit. However, since the current I3 which flows into the LC parallel resonant circuit is supplied through the second high-frequency component cutoff unit 218 including the capacitor 311, the high-frequency component is cut off from the current I5 which flows into the connection unit 211 although the effect is not enough. This is the same as that in the embodiment of FIG. 6.

The current I5 which flows into the connection unit 211 is supplied from the rectifier circuit 302. In this embodiment, a high-frequency cut off unit for reducing a high-frequency component is not provided. Also, the high-frequency component may remain in the current I6 which is supplied from the first high-frequency component cutoff unit 217 to the rectifier circuit 302. However, the remaining high-frequency component is completely cut off by the first high-frequency component cutoff unit 217, and a high-frequency component does not exist in the current I1 which is supplied from the commercial power supply 301 to the power supply part 210.

Similar to the previous embodiment of FIG. 6, the capacitor 311 in the embodiment of FIG. 7 is effective as a high-frequency component cutoff unit for reducing radiation noises from the connection unit 211 as much as possible, in a case where a large choke coil 303 or a large capacitor 304 cannot be arranged in the heating part 209 because of the problem of a limited space in an image forming device. In addition to this, the embodiment of FIG. 7 can be considered as a further effective unit which makes it possible to use the limited space in the image forming device effectively, for the following reason.

Generally, in the equipment which uses the commercial power supply, including an image forming device, a line filter which includes a coil and a capacitor is mounted between the commercial power supply and the device side power supply part, in order to avoid inclusion of noises from the commercial power supply into the equipment and avoid leakage of noises from the equipment to the commercial power supply side. Although not illustrated in the embodiment of FIG. 1, the line filter is mounted between the commercial power supply 301 and the power supply part 210.

The structure of the above-mentioned line filter is similar to that of the first high-frequency component cutoff unit 217, including the coil 330, the coil 331, the capacitor 332, the capacitor 333, and the capacitor 334, as in the embodiment of FIG. 7. In the embodiment of FIG. 7, the number of mounting parts is reduced by using the line filter and the first high-frequency component cutoff unit 217 in common, and it is possible to use the limited space in the image forming device effectively and reduce the cost of noise prevention parts.

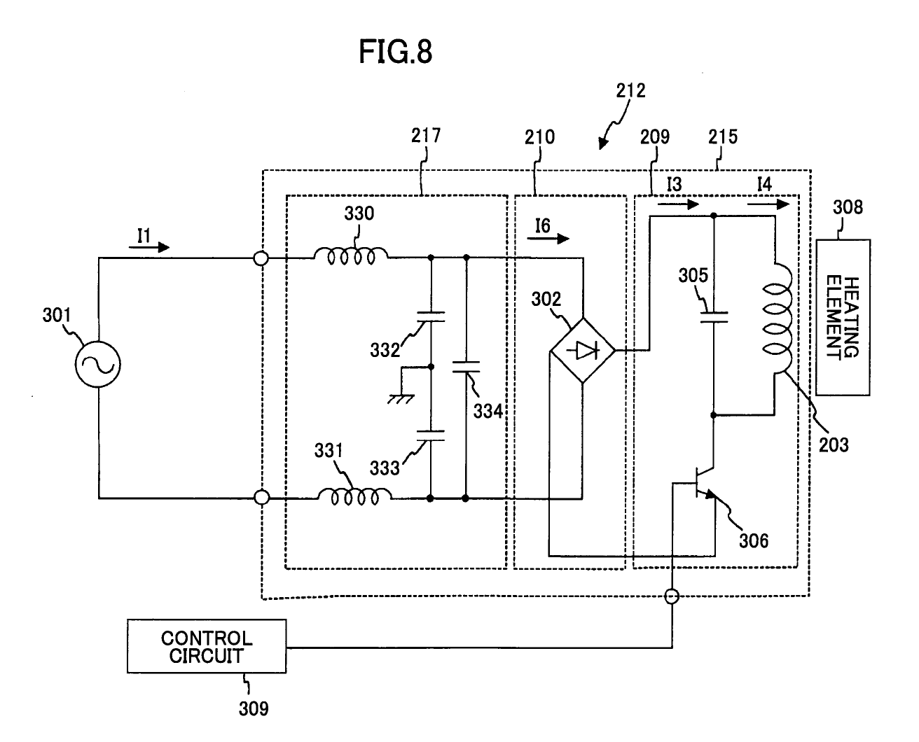

Next, FIG. 8 shows the composition of a fixing driver device 212 in an embodiment of the invention.

As shown in FIG. 8, respective parts of the power supply part 210 and the heating part 209 are implemented on a same PCB 215 and the wiring connecting the respective parts is formed by the shortest distance. One end of the commercial power supply 301 is connected to one end of the coil 330, and the other end of the coil 330 is connected to one end of the capacitor 332. This end is called line side 1 of the capacitor 332.

The other end of the commercial power supply 301 is connected to one end of the coil 331, and the other end of the coil 331 is connected to one end of the capacitor 333. This end is called line side 2 of the capacitor 333. The other end of the capacitor 332 and the other end of the capacitor 333 are connected to the housing of the heater device in the embodiment of FIG. 8.

The line side 1 of the capacitor 332 is connected to one end of the capacitor 334, and the line side 2 of the capacitor 333 is connected to the other end of the capacitor 334. The coil 330, the coil 331, the capacitor 332, the capacitor 333, and the capacitor 334 constitute a high-frequency component cutoff unit 217.

The line side of the capacitor 332 1 and the line side 2 of the capacitor 333 are connected to two ac inputs of the rectifier circuit 302, and the rectifier circuit 302 performs full-wave rectification of the commercial alternating current voltage.

The full-wave rectification voltage output of the rectifier circuit 302 is connected to one end of the LC parallel resonant circuit which includes the excitation coil 203 and the resonance capacitor 305. The other end of the LC parallel resonant circuit is connected to the collector of the switching unit 306, and the emitter of the switching unit 306 is connected to the low-voltage side output of the rectifier circuit 302.

A driving signal outputted from the control circuit 309 is connected to the base of the switching unit 306. When the driving signal from the control circuit 309 causes switching ON and OFF of the switching unit 306, a high frequency current flows into the excitation coil 203, and an alternating-current magnetic field is irradiated to the heating element 308, so that an eddy current occurs on the surface of the heating element 308 and heat is generated.

In FIG. 8, I1 denotes a current which is supplied from the commercial power supply 301 to the high-frequency component cutoff unit 217 which includes the coil 330, the coil 331, the capacitor 332, the capacitor 333, and the capacitor 334, and this current has the waveform of FIG. 5A. I6 denotes a current which is supplied from the high-frequency component cutoff unit 217 to the power supply part 210, and this current has the waveform of FIG. 5F.

In FIG. 8, I3 denotes a current which is supplied from the full-wave rectification voltage output of the rectifier circuit 302 to the LC parallel resonant circuit, including the excitation coil 203 and the resonance capacitor 305, and this current has the waveform of FIG. 5C. I4 denotes a current which flows into the excitation coil 203, and this current has the waveform of FIG. 5D.

When the switching unit 306 turns on and off the supply of the current to the LC parallel resonant circuit which includes the excitation coil 203 and the resonance capacitor 305, the current I3 containing the high-frequency component flows into the LC parallel resonant circuit.

Since no high-frequency cut off unit is provided, the current I6 which supplied from the high-frequency component cutoff unit 217 to the rectifier circuit 302 may contain a high-frequency component. However, the high-frequency component is cut off by the high-frequency component cutoff unit 217, and the current I1 supplied from the commercial power supply 301 to the power supply part 210 does not contain a high-frequency component.

In the embodiment of FIG. 8, the component parts are implemented on the PCB 215 and the wiring connecting the parts is formed by the shortest distance.

Although the connection between the rectifier circuit 302 and the LC parallel resonant circuit including the excitation coil 203 and the resonance capacitor 305 is a portion equivalent to the connection unit 211 in the embodiment of FIG. 1 (which is not illustrated in FIG. 8), and the wiring of this connection is formed by the shortest distance.

Since the wiring connecting the respective parts is short when the respective parts are connected by the shortest distance within the PCB 215, the level of radiation noises can be made low and the problem of high-frequency component from the PCB 215 will not arise.

Even if a noise problem arises, shielding radiation noises within the PCB 215 can be performed easily. As mentioned above, although a high-frequency component exists in the current which flows into the connection unit 211 (which is not illustrated in FIG. 8), the level of radiation noises is low, the problem that meeting the EMI related standard requirement is difficult, or the problem of a malfunction of the control circuit caused by noises will not arise. Since it is not necessary to use electric wires for the connection unit 211, the cost of wiring material can be reduced.

Similar to the previous embodiment of FIG. 7, the line filter, as in the equipment which uses the commercial power supply, including the image forming device, is mounted between the commercial power supply and the device side power supply part in this embodiment, in order to avoid inclusion of noises from the commercial power supply into the equipment and avoid leakage of noises from the equipment to the commercial power supply side. Also in the embodiment of FIG. 8, the number of mounting parts is reduced by sharing the line filter and the high-frequency component cutoff unit 217, and it is possible to use the limited space in the equipment effectively and reduce the cost of noise prevention parts.

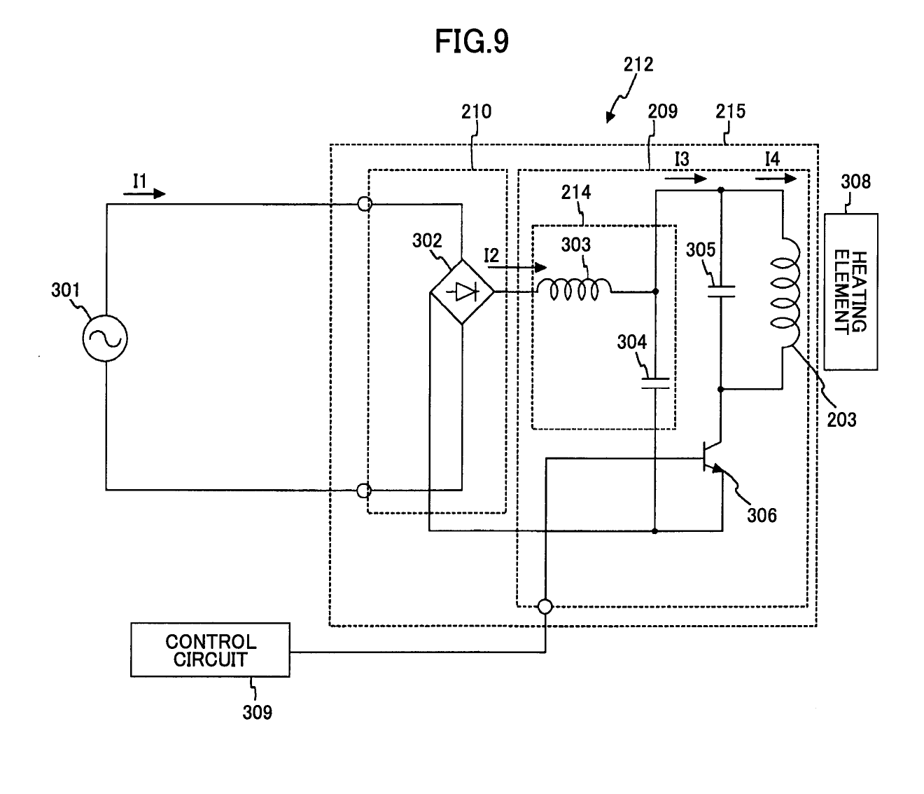

When a line filter is required for another power supply path and it must be mounted near the commercial power supply 301, or when a line filter cannot be mounted on the PCB 215 because of a limited space, a high-frequency component cutoff unit 214 including a choke coil 303 and a capacitor 304 may be arranged between the rectifier circuit 302 and the LC parallel resonant circuit including the resonance capacitor 305 and the excitation coil 203, as shown in FIG. 9.

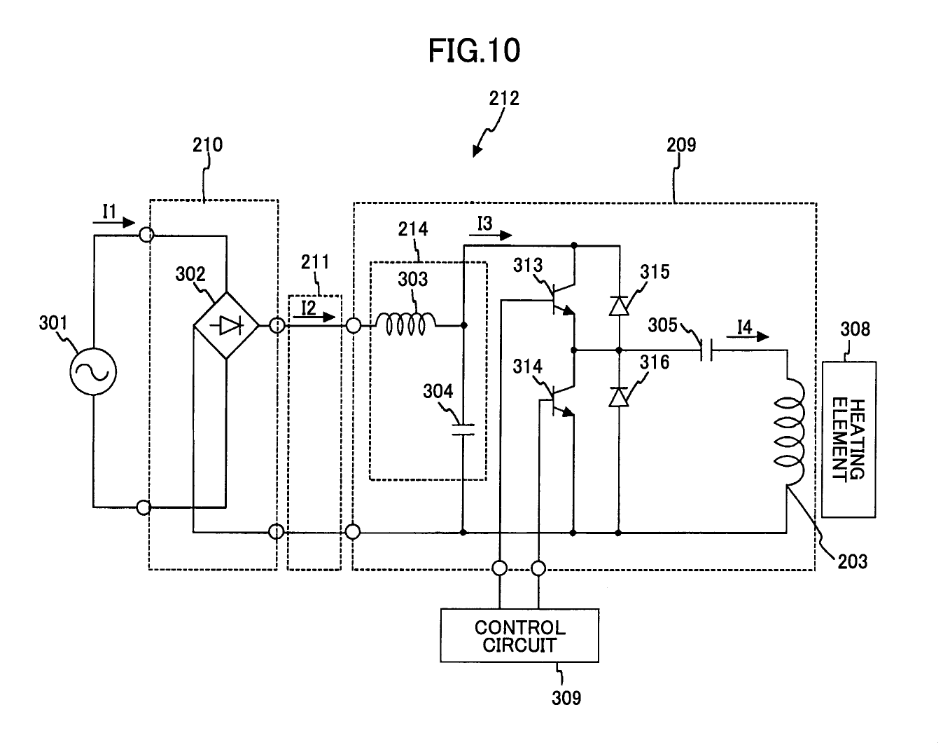

Next, FIG. 10 shows the composition of a fixing driver device 212 in an embodiment of the invention.

As shown in FIG. 10, the commercial power supply 301 is connected to the rectifier circuit 302, and the rectifier circuit 302 performs full-wave rectification of the commercial alternating current voltage. The full-wave rectification voltage output of the rectifier circuit 302 is connected to one of the two electric wires of the connection unit 211, and this electric wire is connected to one end of the choke coil 303.

The other end of the choke coil 303 is connected to one end of the capacitor 304. Suppose that this end is a high-voltage side of the capacitor 304. The other end of the capacitor 304 is connected to the other of the two electric wires of the connection unit 211, and this electric wire is connected to the low-voltage side output of the rectifier circuit 302. Suppose that the other end is a low-voltage side of the capacitor 304. The choke coil 303 and the capacitor 304 constitute a high-frequency component cutoff unit 214.

The high-voltage side of the capacitor 304 is connected to the collector of the switching unit 313, the emitter of the switching unit 313 is connected to the collector of the switching unit 314, and the emitter of the switching unit 314 is connected to the low-voltage side of the capacitor 304.

Reverse-flow prevention diodes 315 and 316 are connected in parallel between the collector emitters of the switching units 313 and 314, respectively. The circuit including the switching units 313 and 314 is called a half bridge type switching unit (or half bridge circuit).

The connection part of the emitter of the switching unit 313 and the collector of the switching unit 314 is connected to one end of the resonance capacitor 305, the other end of the resonance capacitor 305 is connected to one end of the excitation coil 203, and the other end of the excitation coil 203 is connected to the emitter of the switching unit 314. The excitation coil 203 and the resonance capacitor 305 constitute an LC series resonant circuit.

One of two driving signals from the control circuit 309 is connected to the base of the switching unit 313, and the other driving signal from the control circuit 309 is connected to the base of the switching unit 314. When the driving signal from the control circuit 309 is set in the high state to turn on the switching unit 313, the charging current from the high-voltage side of the capacitor 304 flows into the LC series resonant circuit, including the excitation coil 203 and the resonance capacitor 305. At this time, the driving signal which is connected to the base of the switching unit 314 is set in the low level, and the switching unit 314 is turned off.

Subsequently, the driving signal, connected to the base of the switching unit 313, is set in the low level, and the switching unit 313 is turned off. At this time, the driving signal, connected to the base of the switching unit 314, is set in the high-level, and the switching unit 314 is turned on. The discharging current flows into the LC series resonant circuit including the excitation coil 203 and the resonance capacitor 305.

When the two driving signals set the switching units 313 and 314 in ON and OFF states alternately, the high frequency current flows by repetition of the flow of charging current and discharging current in the excitation coil 203, and an alternating-current magnetic field is irradiated to the heating element 308, so that an eddy current occurs on the surface of the heating element 308 and heat is generated.

In this case, if the switching unit 313 and 314 are turned on simultaneously, the switching units 313 and 314 is in a short circuit state and the flow of a large amount of current causes fracturing. The control circuit 309 controls the driving signals so that both the switching units are not turned on simultaneously. Depending on the characteristics of the switching unit 313 and 314, the response at the time of a driving signal turning off the switching unit may be later than that at the time of a driving signal turning on the switching unit. It is preferred to provide a fixed time of lag between the time one driving signal turns off one switching unit and the time the other driving signal turns on the other switching unit, so that the switching units 313 and 314 may not be in ON state simultaneously.

In FIG. 10, I1 denotes a current which is supplied from the commercial power supply 301 to the power supply part 210, and this current has the waveform of FIG. 5A. I2 denotes a current which is supplied from the power supply part 210 to the heating part 209 and flows through the connection unit 211, and this current has the waveform of FIG. 5B.

In FIG. 10, I3 denotes a current which is supplied from the high-frequency component cutoff unit 214, including the choke coil 303 and the capacitor 304, to the half bridge circuit, and this current has the waveform of FIG. 5C. I4 denotes a current which flows into the LC series resonant circuit including the excitation coil 203 and the resonance capacitor 305, and this current has the waveform of FIG. 5D.

In the LC series resonant circuit constituted by the half bridge circuit of FIG. 10, the switching units 313 and 314 turn on and off the supply of the current to the LC series resonant circuit which includes the excitation coil 203 and the resonance capacitor 305, and the current I3 containing the high-frequency component flows into the half bridge circuit.

However, since the current I3 which flows into the half bridge circuit is supplied through the high-frequency component cutoff unit 214 which includes the choke coil 303 and the capacitor 304, a high-frequency component does not exist in the current I2 which flows into the connection unit 211. Therefore, neither the problem that meeting the EMI related standard requirement is difficult due to radiation noises generated from the connection unit 211, nor the problem of a malfunction of the control circuit due to radiation noises arises.

Since no high voltage is applied to the connection unit 211, it is not necessary to use the electric wires which are high voltage resistant and conduct a large amount of current, and the cost of wiring material can be reduced.

Moreover, the problem that if the electric wires of the connection unit 211 are too long, the current waveform varies and occurrences of radiation noises increases does not arise, and the distance restrictions will not arise. Therefore, the restrictions related to the location where the power supply part 210 is arranged will not arise.

In the embodiment of FIG. 10, the single voltage resonance type switching unit in the previous embodiment of FIG. 1 is replaced by the half bridge circuit. Similarly, in the embodiments of FIG. 6, FIG. 7 and FIG. 8, the single voltage resonance type switching unit may be replaced by the half bridge circuit.

As in the foregoing, the cases in which the invention is applied to a fixing unit of an image forming device have been explained. However, the present invention is applicable also to any of various heater devices using the induction-heating method.

The present invention is not limited to the above-described embodiments, and variations and modifications may be made without departing from the scope of the present invention.

The present application is based on and claims the benefit of priority of Japanese patent application No. 2006-132251, filed on May 11, 2006, the entire contents of which are hereby incorporated by reference.

What is claimed is:

1. A heater device comprising:
a heating unit including a heating element that generates heat using an induction-heating method;
a power supply part supplying a driving current to the heating unit;
a first high-frequency component cutoff unit connected to the power supply part;
a switching unit controlling the supply of the driving current from the power supply part to the heating unit;
a second high-frequency component cutoff unit connected to the switching unit; and
a connection unit connecting the first high-frequency component cutoff unit and the second high-frequency component cutoff unit.

2. The heater device according to claim 1, wherein the switching unit is a single voltage resonance type switching unit.

3. The heater device according to claim 1, wherein the switching unit is a half bridge type switching unit.

4. A heater device comprising:
a heating unit including a heating element that generates heat using an induction-heating method;
a power supply part supplying a driving current to the heating unit;
a first high-frequency component cutoff unit connected between the power supply part and a commercial power supply;
a switching unit controlling the supply of the driving current from the power supply part to the heating unit;
a second high-frequency component cutoff unit connected to the switching unit; and
a connection unit connecting the second high-frequency component cutoff unit and the power supply part.

5. The heater device according to claim 4, wherein the switching unit is a single voltage resonance type switching unit.

6. The heater device according to claim 4, wherein the switching unit is a half bridge type switching unit.

7. A heater device comprising:
a heating unit including a heating element that generates heat using an induction-heating method;
an LC resonant circuit including an excitation coil and a resonance capacitor;
a power supply part supplying a driving current to the LC resonant circuit;
a high-frequency component cutoff unit connected between the power supply part and a commercial power supply; and
a switching unit controlling the supply of the driving current from the power supply part to the LC resonant circuit,
wherein the switching unit, the resonance capacitor, the power supply part, and the high-frequency component cutoff unit are implemented on a same substrate.

8. The heater device according to claim 7, wherein the switching unit is a single voltage resonance type switching unit.

9. The heater device according to claim 7, wherein the switching unit is a half bridge type switching unit.
